(19) United States
(12) Patent Application Publication
(10) Pub. No.: US 2009/0032391 A1
(43) Pub. Date: Feb. 5, 2009

(54) DEVICE AND METHOD FOR PHOTOLYSIS-ASSISTED ELECTROLYSIS

(76) Inventors: Robert Brian Dopp, Marietta, GA (US); Kimberly McGrath, Newport Beach, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 12/114,718

(22) Filed: May 2, 2008

Related U.S. Application Data
(60) Provisional application No. 60/915,619, filed on May 2, 2007.

(51) Int. Cl. C01B 3/02

(52) U.S. Cl. 204/242; 48/61; 204/157.52

(57) ABSTRACT

A photolysis-assisted electrolysis device comprises at least one fluidized bed disposed in the device's housing wherein the fluidized bed comprises a reaction medium and photolysis-catalyzing nanoparticles suspended in the reaction medium. When the fluidized bed is exposed to light, the nanoparticles catalyze the photolysis of the reaction medium to form donor electrons. The donor electrons promote reduction of the reaction medium during an electrolysis reaction, for example, the reduction of water to form hydrogen gas.

### PRIORITY INFORMATION

This application is based on and claims priority to U.S. Provisional Patent Application No. 60/915,619, filed May 2, 2007, the entire contents of which are hereby expressly incorporated by reference.

### BACKGROUND

1. Technical Field

The inventions disclosed herein generally relate to photochemical and electrochemical reactions for electrolysis.

2. Description of the Related Art

Hydrogen is a renewable fuel that produces zero emissions when used in a fuel cell. In 2005, the Department of Energy (DoE) developed a new hydrogen cost goal and methodology, namely to achieve $2.00-3.00/gasoline gallon equivalent (gge, delivered, untaxed, by 2015), independent of the pathway used to produce and deliver hydrogen.

Today, the principal method to produce hydrogen is steam reformation. Nearly 95% of the hydrogen presently being produced is made by steam reformation, where natural gas is reacted on metallic catalyst at high temperature and pressure. While this process has the lowest cost, four pounds of the greenhouse gasses carbon monoxide (CO) and carbon dioxide (CO₂) are produced for every one pound of hydrogen. Without further costly purification to remove CO and CO₂, the hydrogen fuel cell cannot operate efficiently.

An alternative to steam reformation is electrolysis. Around 5% of hydrogen presently being produced is from water electrolysis. In this process, electrodes are submerged in water, and energy is applied to them. Using this energy, the electrodes split water molecules into hydrogen and oxygen. Hydrogen is produced at the cathode electrode which accepts electrons and oxygen is produced at the anode electrode which liberates electrons. Because water electrolysis produces only hydrogen and oxygen, water electrolysis has an advantage over steam reformation in that greenhouse gasses are not produced.

Conventional water electrolysis also has disadvantages, primarily inefficiency. The amount of hydrogen and oxygen produced by an electrode is dictated by the current supplied to the respective electrodes. Efficiency depends upon the voltage between the two electrodes and is proportional to the reciprocal of that voltage. That is to say, efficiency increases as the voltage decreases. For an electrolysis device to operate with high efficiency, the amount of product produced during a reaction should be maximized relative to the amount of energy input. In many conventional devices, factors such as cell resistance, inefficient movement of electrolyte, and inefficient collection of reaction products from the electrolyte stream contribute to significant efficiency loss. In some cases, low efficiency is compensated for by operating the cell at a low rate (current). Low current operation increases efficiency, however, it also lowers the amount of hydrogen that can be produced at a given time because hydrogen production rate is directly proportional to the applied current. Presently, the low efficiency of the water electrolysis process prevents this process from being a competitive alternative to steam reformation.

A third alternative to steam reformation is photolysis, a chemical reaction in which a chemical compound is broken down by photons of light. In water photolysis, water is dissociated into hydrogen and oxygen. Photolysis is notoriously inefficient due to many physical design constraints including the need for the electrolyte to flow over the reactive surface without absorbing too much of the energy from the incoming photons. Photolysis reactions, using conventional catalysts and device design, are generally not commercially feasible to produce a significant volume of product, for example hydrogen, from water.

### SUMMARY

In various embodiments disclosed herein, a device and method for photolysis-assisted electrolysis is disclosed that can operate both at high rates and efficiencies. The device and method use the three-dimensional quality of a fluidized bed to eliminate many of the limitations of a photolysis hydrogen generator. Moreover, the function of an electrolysis system is improved by assisting that reaction with electrons generated by the photolysis reaction. The result is a synergistic photolytic-electrolytic system that uses less electricity per amount of hydrogen produced, thereby improving the efficiency of either electrolysis and photolysis alone.

In one embodiment, an electrolysis device is provided. The electrolysis device comprises a housing, wherein at least part of the housing permits transmission of photons of light therethrough, preferably transparent or substantially so. The device also comprises an anode and a cathode and a separator disposed in the housing configured to separate the anode and the cathode and form an anodic reaction zone and a cathodic reaction zone within the housing. The device is configured to form in use at least one fluidized bed disposed in the housing wherein the fluidized bed comprises a reaction medium and photolysis-catalyzing nanoparticles suspended in the reaction medium. The device can further comprise one or more mirrors configured to direct light from a light source toward the at least one fluidized bed. The housing can be tubular, flat, or other suitable shapes.

The at least one fluidized bed can be located in the cathodic reaction zone or in the anodic reaction zone. A fluidized bed can be located in the cathodic reaction zone and a fluidized bed can be located in the anodic reaction zone. The location is dictated by where the photons are directed. The at least one fluidized bed can further comprise electrolysis-catalyzing nanoparticles suspended in the reaction medium.

The photolysis-catalyzing nanoparticles can comprise a metal or semiconductor material configured to absorb photons. The photolysis-catalyzing nanoparticles can comprise a metal or semiconductor selected from a group consisting of titanium, indium, gallium, cadmium, selenium, and combinations, alloys, and oxides thereof. The photolysis-catalyzing nanoparticles can comprise a metal or metal oxide core and an oxide shell, wherein the oxide shell has a thickness in a range from about 5% to about 99% of the total particle thickness. The photolysis-catalyzing nanoparticles can have an effective diameter less than about 1 μm, 100 nm, or 50 nm.

The electrolysis-catalyzing nanoparticles can comprise reduction-catalyzing or oxidation-catalyzing nanoparticles. The electrolysis-catalyzing nanoparticles can comprise a metal selected from a group consisting of nickel, iron, manganese, cobalt, tin, and silver, and combinations, alloys, and oxides thereof. The electrolysis-catalyzing nanoparticles can comprise a metal or metal oxide core and an oxide shell, wherein the oxide shell has a thickness in a range from about 5% to about 99% of the total particle thickness. The electrolysis-catalyzing nanoparticles can have an effective diameter less than about 1 μm, 100 nm, or 50 nm.

The reaction medium can be selected from the group consisting of water, ammonia, and hydrocarbons.

In another embodiment, a hydrogen generator is provided. The hydrogen generator comprises a housing, wherein the housing comprises a first portion that is transparent to solar rays and a second portion. The hydrogen generator also comprises a separator disposed within the housing that forms a cathodic reaction zone proximate the first portion of the housing and an anodic reaction zone proximate the second portion of the housing, a cathode disposed with the cathodic reaction zone, and an anode disposed within the anodic reaction zone. The generator is configured to form in use a fluidized bed disposed within the cathodic reaction zone wherein the fluidized bed comprises a reaction medium and photolysis-catalyzing nanoparticles suspended in the reaction medium.

The generator can further comprise a pump that moves the reaction medium through the anodic reaction zone, at least one agitator that agitates the at least one fluidized bed, and/or a mirror that directs light toward the first portion of the housing. The fluidized bed can further comprise reduction-catalyzing nanoparticles suspended in the reaction medium.

In another embodiment, a method for producing hydrogen is provided. The method comprises providing an electrolysis cell containing a fluidized bed comprising a reaction medium and photolysis-catalyzing nanoparticles suspended in the reaction medium. The method further comprises exposing the fluidized bed to light and producing donor electrons, applying a negative current to a cathode and producing donor electrons, and applying a positive current to an anode and reducing the reaction medium using the donor electrons to produce hydrogen gas.

The method can further comprise positioning a mirror to direct light from a light source toward the fluidized bed and/or moving the mirror to track a moving light source.

### BRIEF DESCRIPTION OF THE DRAWINGS

FIG. 1 is a schematic of a traditional electrolysis device.

FIG. 2 is a top plan view of a tubular-shaped photolysis-assisted electrolysis device.

FIG. 3A is a cross-sectional view of one embodiment of a photolysis-assisted electrolysis device showing first and second chambers positioned concentrically in a vertical orientation.

FIG. 3B is an end view of the embodiment of FIG. 3A.

FIG. 4 is a graph showing the relationship of particle size to percent surface atoms in that particle.

FIG. 5 is a side view of a flat photolysis-assisted electrolysis device.

### DETAILED DESCRIPTION OF CERTAIN PREFERRED EMBODIMENTS

For purposes of summarizing the inventions and the advantages achieved over the prior art, certain items and advantages of the inventions are described herein. Of course, it is to be understood that not necessarily all such items or advantages may be achieved in accordance with any particular embodiment of the inventions. Thus, for example, those skilled in the art will recognize that the inventions may be embodied or carried out in a manner that achieves or optimizes one advantage or group of advantages as taught or suggested herein without necessarily achieving other advantages as may be taught or suggested herein.

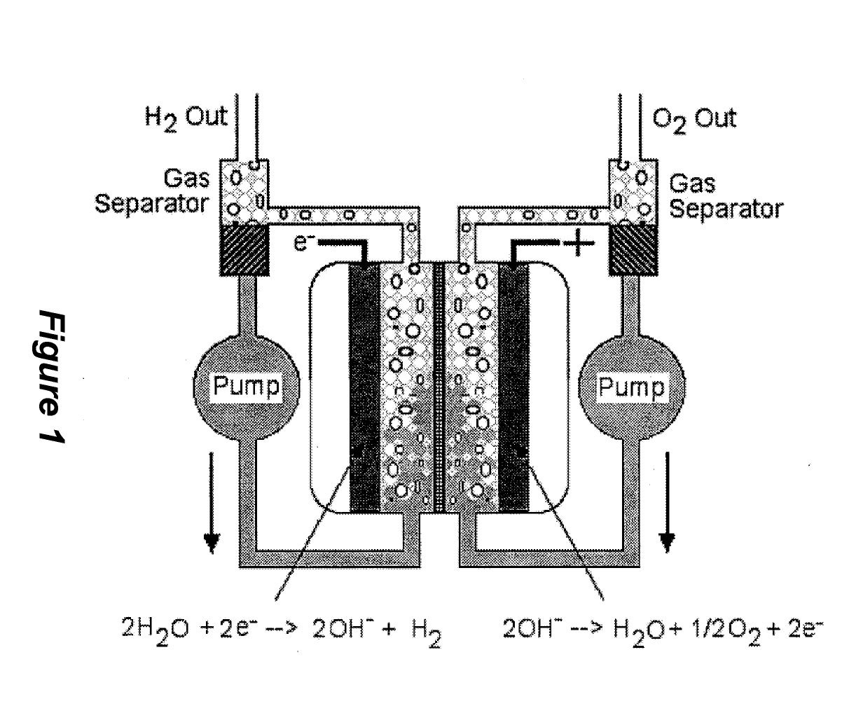

FIG. 1 illustrates a traditional water electrolysis system. The main features of this system are pumps circulating at the anode and cathode to remove resulting oxygen and hydrogen gasses, respectively. The electrodes are typically oriented in a vertical fashion and are substantially solid, typically metal or electrodeposited metal with relatively low surface area.

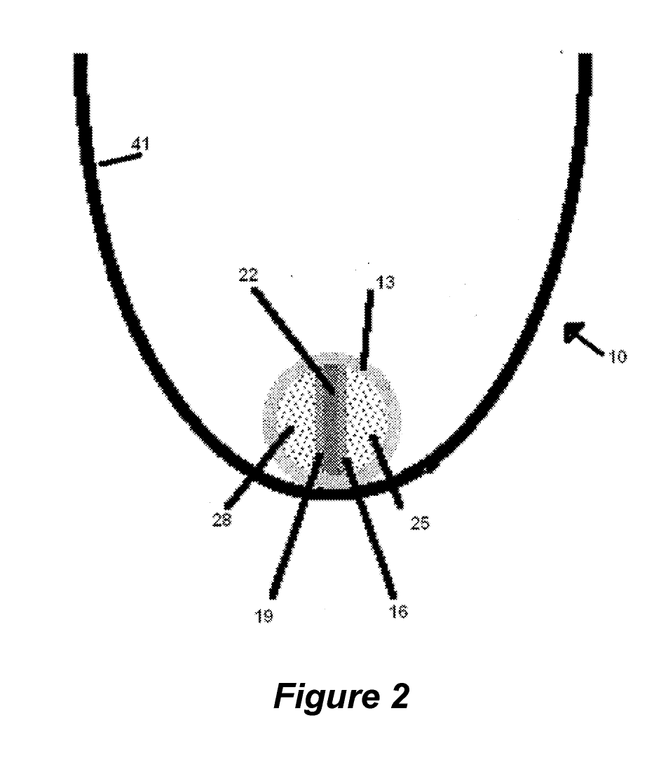

FIG. 2 shows an embodiment of an improved electrolysis device 10. The device comprises a tubular housing 13. The housing comprises a corrosion-resistant material that allows photons to pass through the material and enter the reaction zone which is immediately touching the inner surface of the housing 13. In certain embodiments, the housing 13 is transparent. A suitable material for the housing can be, for example, SiO₂ (glass or quartz). Other regular and irregular geometric configurations (e.g., cubic, spherical, hemi-spherical, etc.) are also suitable.

An cathode 16 and an anode 19 are disposed within the housing 13. In certain embodiments, the cathode 16 is a negative electrode. That is to say, during electrolysis, a negative current is supplied to the cathode 19. In the electrolysis of water in a basic electrolyte such as potassium hydroxide (KOH), a reduction reaction takes place at the cathode in which water molecules (H₂O) accept donor electrons (e⁻) to form hydrogen gas (H₂) according to the following formula:

2H₂O+2e⁻-->H₂+2OH⁻ 100

In certain embodiments, the anode 16 is a positive electrode. That is to say, during electrolysis, a positive current is supplied to the anode 16. In the electrolysis of water in KOH, an oxidation reaction occurs at the anode that creates oxygen gas and donor electrons for the cathodic reaction according to the following formula:

2OH⁻-->½O₂+H₂O+2e⁻ 110

Accordingly, the overall cell reaction for water electrolysis is:

H₂O-->H₂+½O₂ 120

The cathode 16 and anode 19 are at least partly submerged in a reaction medium (not shown) disposed within the housing 13. The reaction medium is the medium that is chemically dissociated during the electrolysis reaction. The reaction medium can be, for example, water, ammonia, or a hydrocarbon.

In the example embodiment of FIG. 1, a separator 22 is disposed within the housing 13. The separator 22 is configured to separate the cathode 16 from the anode 19 and create a cathodic reaction zone 25 and an anodic reaction zone 28, respectively. Certain embodiments do not include a separator 22 and the cathodic reaction zone 25 and anodic reaction zone 28 are defined by the electronic influence of the cathode 16 and anode 19, respectively. In the particular embodiment shown, the separator 22 is substantially planar. Accordingly, the cathodic reaction zone 25 and anodic reaction zone 28 are side by side. This configuration advantageously allows both the cathodic reaction zone 25 and the anodic reaction zone 28 to both be exposed to light simultaneously. Preferably, the reaction medium, e.g., water, can move through the separator and the separator is permeable to electrons and ions (e.g., hydroxyl ions).

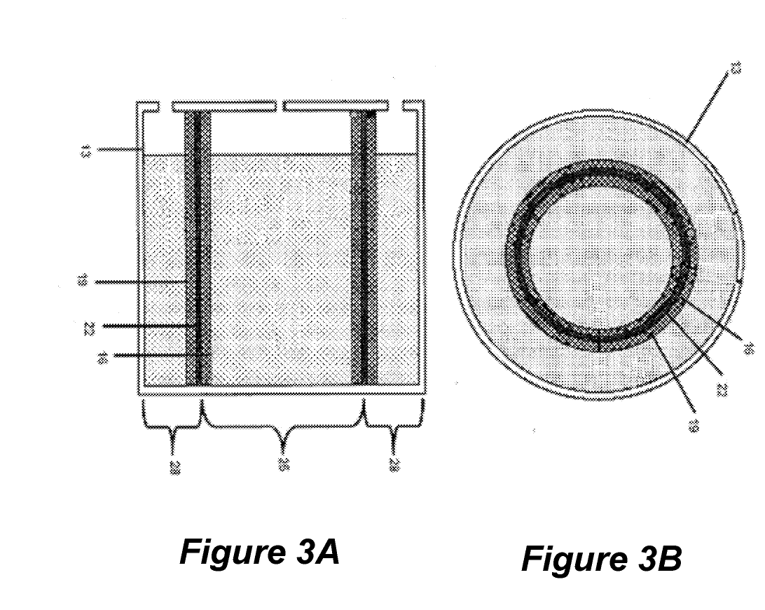

In an embodiment shown in FIGS. 3A and 3B, the separator 22 is generally cylindrical and aligned concentrically with the housing 13. The electrodes are disposed on each side of the separator 22. The anode 19 is disposed on the outer surface and cathode 16 is disposed on the inner surface. Accordingly, the anodic reaction zone 28 is disposed on the outer surface of the separator 22 and the cathodic reaction zone 25 is disposed on the inner surface of the separator 22. Both the anodic reaction zone 28 and cathodic reaction zone are filled with an electrolyte and/or reaction medium.

Referring to FIG. 2, at least one fluidized bed comprising photolysis-catalyzing nanoparticles suspended in the reaction medium (“photolysis bed”) is disposed within the housing 13. As used herein, the term “nanoparticle” refers to a particle with a maximum dimension of from about 1 to about 999 nanometers (10⁻⁹ meters). Because the particles are generally spherical in some embodiments, this dimension is also referred to herein as the “effective diameter” of a particle, although other shapes are also observed. The number of atoms comprising a nanoparticle rapidly increases as nanoparticle size increases from ones to hundreds of nanometers. Roughly, the number of atoms increases as a function of the cube of the particle's effective diameter. Nickel nanoparticles, for example, have about 34 atoms in a 1 nm particle, about 34 million atoms in a 100 nm particle, and about 34 billion in a 1 micron particle.

The photolysis-catalyzing nanoparticles are suspended in the reaction medium by rising gas bubbles (e.g., H₂ or O₂) that form at the electrode(s) and travel upward through the electrolyte and/or reaction medium. Thus, the fluidized bed is, in certain embodiments, self-propagating without a need for additional agitation. Ions and electrons are free to meander throughout the fluidized bed. The photolysis-catalyzing nanoparticles catalyze photolysis of the reaction medium to form donor electrons that are subsequently used in a reduction reaction. In the photolysis of water, for example, the photolysis-catalyzing nanoparticles catalyze the formation of donor electrons according to a reaction represented by the following formula:

H₂O+4 photons (light)→2e⁻+2H⁺+½O₂ 130

The donor electrons are subsequently used at the cathode to promote the reduction of water to form hydrogen gas according to the reaction as shown above in formula 100. Suitable photolysis-catalyzing nanoparticles are configured to absorb photons. In certain embodiments, the photolysis-catalyzing nanoparticles comprise a metal or semiconductor configured to absorb photons from light. Preferably, the nanoparticles are selected from the group consisting of titanium, indium, gallium, cadmium, selenium, or combinations, alloys, and oxides thereof. Additionally, the photolysis-catalyzing nanoparticles can comprise a metal core and an oxide shell having a thickness in the range from about 5 to 99% of the total particle composition. In certain embodiments, the metal core is a metal alloy. In certain embodiments, the effective diameter of the photolysis-catalyzing nanoparticles is less than about 1 μm. Preferably, the effective diameter of the photolysis-catalyzing nanoparticles is less than about 100 nm. More preferably, the effective diameter of the photolysis-catalyzing nanoparticles is less than about 50 nm.

In the example embodiment of FIG. 1, two fluidized beds are disposed within the tubular housing 13. A first fluidized bed is a photolysis bed located in the cathodic reaction zone 25. A second photolysis bed is a photolysis bed located in the anodic reaction zone 28. In certain embodiments, the catalyzing nanoparticles suspended in the cathodic reaction zone 25 and the anodic reaction zone 28 make contact with the cathode 16 and anode 19, respectively through a percolation pathway. The percolation pathway is established when a plurality of the catalyzing nanoparticles make direct contact with an electrode as well as indirect contain through a chain of nanoparticles that ultimately make contact with the electrode.

The fluidized bed offers several distinct advantages compared with the traditional electrolysis device shown in FIG. 1. First, in traditional electrolysis devices, the entire volume of electrolyte and/or reaction medium fed into the system requires pumping and removal of hydrogen and oxygen gasses from the cathode and anode, respectively, resulting in parasitic losses. However, pumping is eliminated when a fluidized bed is established. Second, once fluidization occurs, considerably larger amounts of gas can be produced composed to a traditional electrolysis device. Finally, the device could be scaled to any conceivable size.

In certain embodiments, a photolysis bed further comprises electrolysis-catalyzing nanoparticles suspended in the reaction medium (“combination photolysis-electrolysis bed”). As described above, the bed of photolyis- and electrolysis-catalyzing nanoparticles is fluidized in the electrolyte and/or reaction medium by gas bubbles evolved at the electrodes. As an example, in certain embodiments, the first fluidized bed 28 located in the cathodic reaction zone 25 further comprises both photolysis-catalyzing nanoparticles and reduction-catalyzing nanoparticles such as hydrogen reduction-catalyzing nanoparticles. As another example, in certain embodiments, the second fluidized bed located in the anodic reaction zone 28 comprises both photolysis-catalyzing nanoparticles and oxidation-catalyzing nanoparticles.

The electrolysis-catalyzing nanoparticles referenced herein are preferably selected from the group of metals from groups 3-16 of the periodic table, and the lanthanide series. More preferably, the metals are transition metals, mixtures thereof, and alloys thereof and their respective oxides. Most preferably, the metal or metals are selected from the group consisting of nickel, iron, manganese, cobalt, tin, and silver, or combinations, alloys, and oxides thereof. The electrolysis-catalyzing nanoparticles may be the same as, substantially the same, or entirely different materials from those chosen for the electrodes. Additionally, the electrolysis-catalyzing nanoparticles can comprise a metal core and an oxide shell having a thickness in the range from about 5 to about 99% of the total particle composition. In certain embodiments, the metal core is a metal alloy. In certain embodiments, the effective diameter of the photolysis-catalyzing nanoparticles is less than about 1 μm. Preferably, the effective diameter of the photolysis-catalyzing nanoparticles is less than about 100 nm. More preferably, the effective diameter of the photolysis-catalyzing nanoparticles is less than about 50 nm. Preferred electrolysis-catalyzing nanoparticles are disclosed in U.S. patent application Ser. No. 11/716,375, which is herein incorporated by reference in its entirety.

In certain embodiments, a fluidized bed comprising electrolysis-catalyzing nanoparticles suspended in the reaction medium (“electrolysis bed”) but not photolysis-catalyzing nanoparticles is disposed within the housing 13. Such a fluidized bed can, for example, be located in a portion of the housing that is not exposed to light 13.

Many combinations of fluidized beds can be located in the housing 13. Certain embodiments comprise a single photolysis bed. For instance, a single fluidized bed can be present in the cathodic reaction zone 25 while the anodic reaction zone contains only the reaction medium or the reaction medium and an electrolyte. Certain embodiments comprise two photolysis beds, as discussed above. Certain embodiments comprise a single combination photolysis-electrolysis bed. Certain embodiments comprise at least two combination photolysis-electrolysis beds. Certain embodiments comprise a photolysis bed and an electrolysis bed. Certain embodiments comprise a combination photolysis-electrolysis bed and an electrolysis bed.

In certain embodiments, the first fluidized bed comprises the same photolysis-catalyzing nanoparticles as the second fluidized bed. In certain embodiments, the first and second fluidized beds comprise different photolysis-catalyzing nanoparticles. In certain embodiments, the first fluidized bed comprises the same concentration of photolysis-catalyzing nanoparticles, electrolysis-catalyzing nanoparticles, or both as the second fluidized bed. In certain embodiments, the first and second fluidized beds comprise different concentrations of photolysis-catalyzing nanoparticles, electrolysis-catalyzing nanoparticles, or both.

Unlike a traditional electrolysis device, whose efficiency decreases as current increases, an electrolysis device with at least one fluidized bed as described in the preferred embodiments will increase in efficiency as current is increased, until a limiting current is reached in which further gas generation disrupts fluidization and the percolation pathway, ultimately lowering efficiency. Nevertheless, this limiting current at maximum efficiency is significantly higher in the devices described in the preferred embodiments compared to a traditional electrolysis system.

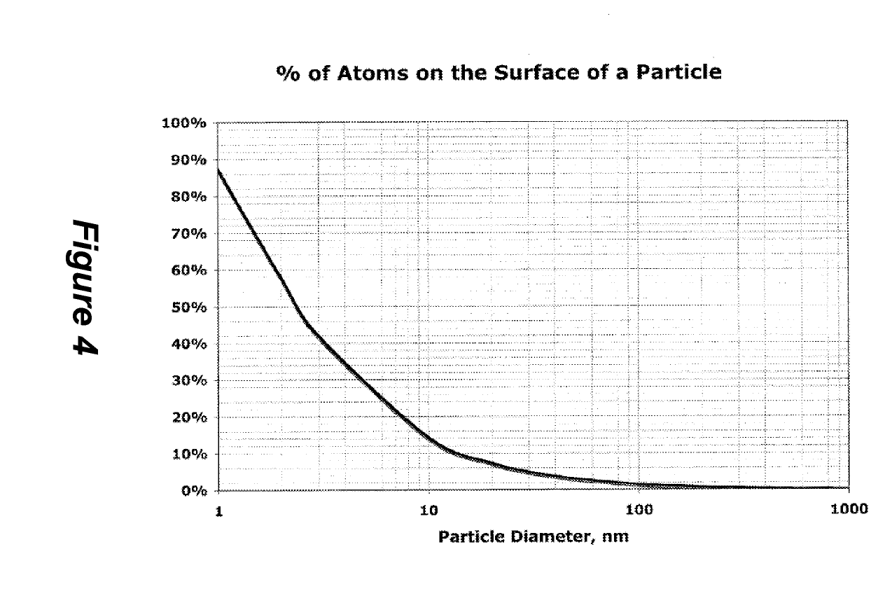

Reactive surface area is increased by order of magnitude by operation with catalyzing nanoparticles in the fluidized bed. In addition to the surface area of the porous or reticulate electrode, and nanoparticles infused into the electrode, the fluidized bed configuration capitalizes on the additional surface area created by the fluidized catalyzing nanoparticles. The increased catalytic behavior of the catalyzing nanoparticles, compared to the surface of the electrode alone, is high due to the very large number of atoms on the surface of the nanoparticles, as shown in FIG. 4. By way of demonstration, consider a 3 nanometer nickel particle as a tiny sphere. Such a sphere would have 384 atoms on its surface and 530 within its interior, of the 914 atoms in total. This means that 58% of the nanoparticles would have the energy of the bulk material and 42% would have higher energy due to the absence of neighboring atoms. Nickel atoms in the bulk material have about 12 nearest neighbors while those on the surface have nine or fewer. A 3 micron sphere of nickel would have 455 million atoms on the surface of the sphere, 913 billion in the low energy and isolated interior of the sphere for a total of nearly one trillion atoms. That means that only 0.05% of the atoms are on the surface of the 3 micron-sized material compared to the 42% of the atoms at the surface of the 3-nanometer nickel particles.

The catalyzing nanoparticles can be formed through any known manufacturing technique, including, for example, but without limitation, ball milling, precipitation, plasma torch synthesis, combustion flame, exploding wires, spark erosion, ion collision, laser ablation, electron beam evaporation, and vaporization-quenching techniques such as joule heating.

Another possible technique for forming catalyzing nanoparticles includes feeding a material onto a heater element so as to vaporize the material in a well-controlled dynamic environment. Such technique desirably includes allowing the material vapor to flow upwardly from the heater element in a substantially laminar manner under free convection, injecting a flow of cooling gas upwardly from a position below the heater element, preferably parallel to and into contact with the upward flow of the vaporized material and at the same velocity as the vaporized material, allowing the cooling gas and vaporized material to rise and mix sufficiently long enough to allow nano-scale particles of the material to condense out of the vapor, and drawing the mixed flow of cooling gas and nano-scale particles with a vacuum into a storage chamber. Such a process is described more fully in U.S. patent application Ser. No. 10/840,409, filed May 6, 2004, the entire contents of which is hereby expressly incorporated by reference.

The chemical kinetics of catalysts generally depends on the reaction of surface atoms. Having more surface atoms available will increase the rate of many chemical reactions such as combustion, electrochemical oxidation and reduction reactions, and adsorption. Extremely short electron diffusion paths, (for example, 6 atoms from the particle center to the edge in 3 nanometer particles) allow for fast transport of electrons through and into the particles for other processes. These properties give nanoparticles unique characteristics that are unlike those of corresponding conventional (micron and larger) materials. The high percentage of surface atoms enhances galvanic events such as the splitting of water molecules into its composite gasses of hydrogen and oxygen. FIG. 4 shows this relationship well.

In certain embodiments, the electrolysis device 10 further comprises a mirror 41 that directs light towards the fluidized bed or beds within the housing 13 to promote the photolysis reaction. In certain embodiments, the mirror 41 comprises a system of mirrors. In certain embodiments, the mirror 41 is parabolic-shaped and partially envelops the tubular-shaped housing 13. In certain embodiments, the mirror 41 moves to track a moving light source, for example, the sun. In certain embodiments, the fluidized bed or beds are agitated to improve efficiency.

In certain embodiments, multiple devices can be connected for increased surface area and therefore increased hydrogen and oxygen production. An additional advantage to operating multiple cells is that because surface area is increased, internal resistance decreases and lowers parasitic losses.

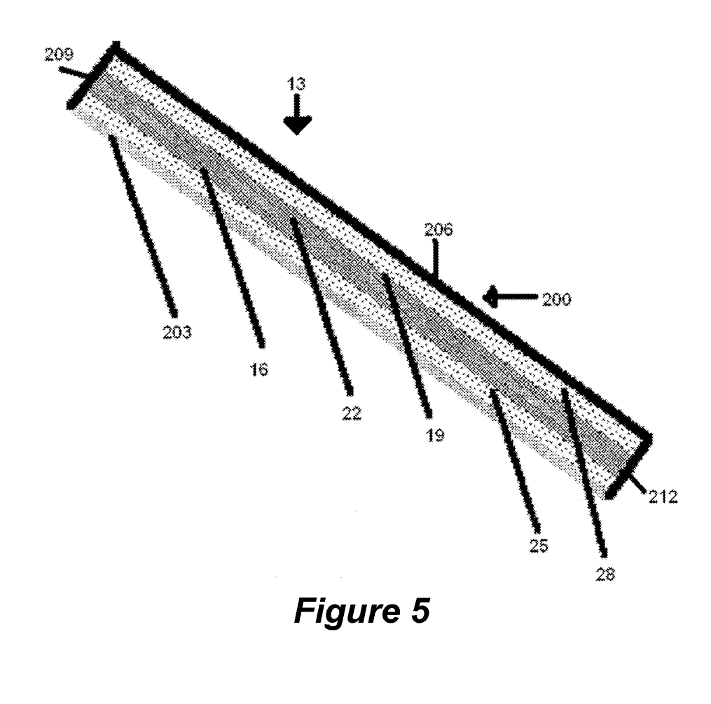

An example embodiment of a flat photolysis-assisted electrolysis device 200 is shown in FIG. 5. The device comprises a flat housing 13. In this example, only a portion of the housing 13 is transparent to photons. For example, Side A 203 (the light-side portion) is transparent or translucent and Side B 206 (the dark-side portion) is opaque. Side C 209 and Side D 212 can be transparent, translucent, or opaque in various embodiments. In the example embodiment of FIG. 5, the first fluidized bed is a combination photolysis-electrolysis bed located in the cathodic reaction zone 25, and the second fluidized bed is an electrolysis bed located in the anodic reaction zone 28. In this way, the photolysis-assisted electrolysis device 10 shown in FIG. 5 is configured such that the photolysis reaction occurs only in the hydrogen generation portion of the device. The photolysis reaction is catalyzed by the photolysis-catalyzing nanoparticles in the combination photolysis-electrolysis bed located in the cathodic reaction zone 25. Photolysis creates donor electrons as described above. The oxidation reaction is catalyzed by the oxidation-catalyzing nanoparticles in the electrolysis bed located in the anodic reaction zone 28. Oxidation also creates donor electrons as described above. The donor electrons are consumed in the reduction reaction that occurs at the cathode to form hydrogen gas. The reduction reaction is further catalyzed by the reduction-catalyzing nanoparticles in the combination photolysis-electrolysis bed located in the cathodic reaction zone 25. In this way, a fluidized bed comprising photolysis-catalyzing nanoparticles is used to efficiently produce hydrogen gas, improving the efficiency of either the photolysis or electrolysis processes alone.

The configuration of FIG. 5 can be mounted onto a roof of a building. In certain embodiments, the device 200 comprises a mirror (not shown) that directs light towards the light-side portion of the housing 13. In certain embodiments, the mirror does not require solar tracking. In certain embodiments, a pump moves the reaction medium through the fluidized bed located adjacent the dark-side portion of the housing, i.e., the second fluidized bed located in the anodic reaction zone 28.

A wide variety of variations are possible. Components may be added, removed, or reordered. Different components may be substituted out. The arrangement and configuration may be different. Similarly, processing steps may be added or removed, or reordered.

Although these inventions have been disclosed in the context of certain preferred embodiments and examples, it will be understood by those skilled in the art that the present inventions extend beyond the specifically disclosed embodiments to other alternative embodiments and/or uses of the inventions and obvious modifications and equivalents thereof. In addition, while several variations of the inventions have been shown and described in detail, other modifications, which are within the scope of these inventions, will be readily apparent to those of skill in the art based upon this disclosure. It is also contemplated that various combinations or sub-combinations of the specific features and aspects of the embodiments may be made and still fall within the scope of the inventions. It should be understood that various features and aspects of the disclosed embodiments can be combined with, or substituted for, one another in order to form varying modes of the disclosed inventions. Thus, it is intended that the scope of the present inventions herein disclosed should not be limited by the particular disclosed embodiments described herein.

We claim:

1. An electrolysis device comprising:
a housing, wherein at least part of the housing permits transmission of light therethrough;
an anode and a cathode;
a separator disposed in the housing configured to separate the anode and the cathode and form an anodic reaction zone and a cathodic reaction zone within the housing;
the device configured to form in use at least one fluidized bed disposed in the housing wherein the fluidized bed comprises a reaction medium and photolysis-catalyzing nanoparticles suspended in the reaction medium.

2. The device of claim 1 wherein the at least one fluidized bed is located in the cathodic reaction zone.

3. The device of claim 1 wherein the at least one fluidized bed is located in the anodic reaction zone.

4. The device of claim 1 wherein a fluidized bed is located in the cathodic reaction zone and a fluidized bed is located in the anodic reaction zone.

5. The device of claim 1 wherein the at least one fluidized bed further comprises electrolysis-catalyzing nanoparticles suspended in the reaction medium.

6. The device of claim 5 wherein the at least one fluidized bed is located in the cathodic reaction zone and the electrolysis-catalyzing nanoparticles comprise reduction-catalyzing nanoparticles.

7. The device of claim 5 wherein the at least one fluidized bed is located in the anodic reaction zone and the electrolysis-catalyzing nanoparticles comprise oxidation-catalyzing nanoparticles.

8. The device of claim 1 wherein the photolysis-catalyzing nanoparticles comprise a metal or semiconductor capable of absorbing photons from light.

9. The device of claim 8 wherein the photolysis-catalyzing nanoparticles comprise a metal or semiconductor selected from a group consisting of titanium, indium, gallium, cadmium, selenium, and combinations, alloys, and oxides thereof.

10. The device of claim 9 wherein the photolysis-catalyzing nanoparticles comprise a metal or metal oxide core and an oxide shell, wherein the oxide shell has a thickness in a range from about 5% to about 99% of the total particle thickness.

11. The device of claim 5 wherein the electrolysis-catalyzing nanoparticles comprise a metal selected from a group consisting of nickel, iron, manganese, cobalt, tin, and silver, and combinations, alloys, and oxides thereof.

12. The device of claim 11 wherein the electrolysis-catalyzing nanoparticles comprise a metal or metal oxide core and an oxide shell, wherein the oxide shell has a thickness in a range from about 5% to about 99% of the total particle thickness.

13. The device of claim 1 wherein the photolysis-catalyzing nanoparticles have an effective diameter less than about 1 μm.

14. The device of claim 13 wherein the photolysis-catalyzing nanoparticles have an effective diameter less than about 100 nm.

15. The device of claim 14 wherein the photolysis-catalyzing nanoparticles have an effective diameter less than about 50 nm.

16. The device of claim 5 wherein the electrolysis-catalyzing nanoparticles have an effective diameter less than about 1 μm.

17. The device of claim 16 wherein the electrolysis-catalyzing nanoparticles have an effective diameter less than about 100 nm.

18. The device of claim 17 wherein the electrolysis-catalyzing nanoparticles have an effective diameter less than about 50 nm.

19. The device of claim 1 wherein the reaction medium is selected from the group consisting of water, ammonia, and hydrocarbons.

20. The device of claim 1 further comprising a mirror configured to direct light from a light source toward the at least one fluidized bed.

21. The device of claim 1 wherein the housing is tubular.

22. The device of claim 1 wherein the housing is flat.

23. A hydrogen generator comprising:
a housing, wherein the housing comprises a first portion that permits transmission of solar rays therethrough and a second portion;
a separator disposed within the housing that forms a cathodic reaction zone proximate the first portion of the housing and an anodic reaction zone proximate the second portion of the housing;
a cathode disposed with the cathodic reaction zone and an anode disposed within the anodic reaction zone; and
the generator configured to form in use a fluidized bed disposed within the cathodic reaction zone wherein the fluidized bed comprises a reaction medium and photolysis-catalyzing nanoparticles suspended in the reaction medium.

24. The generator of claim 23 further comprising a pump that moves the reaction medium through the anodic reaction zone.

25. The generator of claim 23 further comprising at least one agitator that agitates the at least one fluidized bed.

26. The generator of claim 23 further comprising a mirror that directs light toward the first portion of the housing.

27. The generator of claim 23 wherein the at least one fluidized bed further comprises reduction-catalyzing nanoparticles suspended in the reaction medium.

28. A method for producing hydrogen comprising:
providing an electrolysis cell containing a fluidized bed comprising a reaction medium and photolysis-catalyzing nanoparticles suspended in the reaction medium;
exposing the fluidized bed to light and producing donor electrons;
applying a negative current to a cathode and producing donor electrons;
applying a positive current to an anode and reducing the reaction medium using the donor electrons to produce hydrogen gas.

29. The method of claim 28 further comprising positioning a mirror to direct light from a light source toward the fluidized bed.

30. The method of claim 29 further comprising moving the mirror to track a moving light source.
